(19) United States
(12) Patent Application Publication
(10) Pub. No.: US 2010/0128857 A1
(43) Pub. Date: May 27, 2010

(54) CALL FORWARDING SYSTEM AND METHOD EMPLOYING VIRTUAL PHONE NUMBERS ASSOCIATED WITH LANDLINE AND OTHER DISCRETE TELEPHONE UNITS

(76) Inventor: James D. Logan, Candia, NH (US)

Correspondence Address: LOGINOV & ASSOCIATES, PLLC, 10 WATER STREET, CONCORD, NH, 03301, US

(21) Appl. No.: 12/344,073

(22) Filed: Dec. 24, 2008

Related U.S. Application Data
(60) Provisional application No. 61/009,177, filed on Dec. 26, 2007.

(51) Int. Cl. H04M 3/42; H04M 1/64; H04W 64/00

(52) U.S. Cl. 379/88.22; 379/211.02; 455/456.1

(57) ABSTRACT

A system and method for forwarding calls to virtual phone numbers, the virtual phone numbers associated with landline and other discrete telephone units. A user cellular telephone can receive the calls for the virtual phone numbers, based on preferences specified by the user for when and/or where particular calls are forwarded to the device. The user cellular telephone can be interconnected by a network to a system server that employs a forwarding application to forwards calls to the user cellular telephone when desired, in accordance with the preferences specified by the user. If the call is not one desired to be received by the user cellular telephone, the call can be forwarded to a voicemail database where a voicemail message may be stored, as a distinct voicemail for the virtual number dialed by the calling party.

### RELATED APPLICATIONS

This application claims the benefit of U.S. Provisional Application Ser. No. 61/009,177, filed Dec. 26, 2007, entitled LOCATION-BASED CALL FORWARDING SYSTEM, the entire disclosure of which is herein incorporated by reference.

### FIELD OF THE INVENTION

The present invention relates to systems and methods for selectively forwarding calls to specified phone numbers.

### BACKGROUND OF THE INVENTION

So-called “landline” telephones have been a staple item in homes and businesses for over a century. These telephones are connected via wires (or more recently broadcast internet) to a remote telephone exchange. Despite the ubiquitous presence of cellular telephones (cellphones), one of the primary reasons users appear to maintain a landline at the home or office is to filter telephone calls that are desired for that location. By way of example, most users do not want their plumber calling back with an estimate when the user is at the office. Likewise, many users are cautious as to whom they provide with their mobile phone number, to avoid receiving undesired low priority calls when traveling, in meetings, etc.

The same principle applies to an office phone. Many business persons only provide their business landline number, instead of their cellphone, because they do not wish to be bothered with business calls when traveling (and not in situation where they can easily handle such a call, such as in an airport) or at home.

While the home and office landline numbers serve to channel calls to the correct locations, such users might also wish to consolidate their phone usage to just a cellphone and dispense with the use of landlines. This presumes that their cellphone reception is adequate at both locations or that their cellphone can make use of wireless Internet/network connectivity (WiFi), or other alternative networks when reception is poor. Rendering a cellphone as their sole phone can be desirable for cost reasons, the ability to receive all voicemails in one location, or to always maintain ready access to the higher-technology features offered by cellphones.

Local telephone calls are typically less expensive than long-distance phone calls. Accordingly, one attempt to overcome the problem associated with forwarding calls to multiple locations is the recently introduced Grand Central service offered by Google. This service can provide users with an opportunity to obtain a free local number and have calls to that number forwarded to other phones.

A call-forwarding service that became commercially available in 2006 was Grand Central, since bought by the well-known online search engine Google. This service gave away local numbers that can be programmed to be forwarded to other phones used by the user. One of the drawbacks of this service was that when a Grand Central user returned a call, the caller ID (CID) showing up on the phone would be that of the phone being used to make the call (that is, the phone to which calls were being forwarded) and not the Grand Central number that the user called in the first place. This would tend to confuse callers who had been instructed to call the Grand Central number when placing calls. In the case of the MNC system, it would be particularly detrimental if the user was trying to use a cellphone for all calls but trying to protect the privacy of that cellphone number from call parties being called.

There have been several attempts to overcome the problem of reaching a user at a plurality of locations with a telephone call, based on the location of the user and/or proximity of the user to the location. Such an illustrative system is described in U.S. Pat. No. 7,006,833 of Sunil H. Contractor, entitled LOCATION-BASED FORWARDING OF A COMMUNICATION, in which a single incoming call, directed to a called party presumed to be at a first location, is transmitted to another landline phone, based on the called party's proximity to one or more “subscriber locations”. These subscriber locations are pre-defined by a user (the “called party”) but require a plurality of subscriber locations, each employing a distinct landline phone for receiving the calls. While allowing a user to receive a call at multiple locations, this system disadvantageously requires each location to have a landline phone that must be pre-programmed. The subscriber locations must be able to detect the presence of the called party, and also the system must be pre-programmed to detect the precise location of these particular subscriber locations. Accordingly, it is desirable to provide a single device, capable of receiving the calls at multiple locations, without the need for multiple landline telephones.

The continuing challenge for an exclusive cellphone is to be able to maintain distinct home and business numbers and avoid receiving all calls for all numbers at inopportune times and/or locations.

It is thus desirable to provide a user with the ability to employ a single device, such as a cellphone, and eliminate the need for a plurality of landline telephones by using that single device as a primary communication medium, while also allowing the user to maintain a plurality of telephone “numbers” unique to certain circumstances.

### SUMMARY OF THE INVENTION

This invention overcomes disadvantages of the prior art by providing a system and method for call forwarding, employing virtual phone numbers associated with landline and other discrete telephone units, in which a cellular telephone user, based upon his or her unique user preferences, can control the forwarding of calls from the caller to a series of virtual numbers, as well as the users cellular telephone “base” or owned number (i.e. the number that is the user cellular telephone-specific number). The forwarding of calls to the owned number and virtual numbers can be based on a variety of factors. In an illustrative embodiment, the forwarding factors can include the location of the cellular telephone, determined by GPS, triangulation or another mechanism, or the time of day. In this manner, the user can designate a virtual number as a home number, an office number, and a traveling number. Calls are received at each number when the user cellular telephone is located at the predetermined location, or it is the predetermined time of day. When calls are received to one of the virtual numbers, or to the base number, outside of the permitted receipt time, as provided by the user preferences, the call is routed to a voicemail database by the system server, which implements a call forwarding application.

In an illustrative embodiment, the system can provide a plurality of virtual numbers associated with a user cellular telephone that is interconnected by a network to a system server so as to send and receive telephone calls through the network. The system server can employ a forwarding application that includes information with respect to the virtual phone numbers. The forwarding application can assign user preferences to each of the virtual phone numbers, and forward calls to the user cellular telephone based upon preferences specified by the user. These preferences can be based on location of the user cellular telephone and/or the time-of-day.

The calls can also be forwarded to a voicemail database, operatively connected with the system server, if the user is unavailable to answer the phone call, or if it is an inopportune location or time. These calls can be stored as messages to be reviewed by the user. A notification of a message deposited in the voicemail database can also be forwarded to the user cellular telephone to notify the user of the presence of a message on the database.

The virtual phone numbers can comprise a home telephone number, representative of a traditional home phone, or an office telephone number, representative of a traditional office phone network, as well as any other traditional entity for which a discrete phone number is assigned.

### BRIEF DESCRIPTION OF THE DRAWINGS

The invention description below refers to the accompanying drawings, of which:

FIG. 1 shows a block diagram of the general architecture of an illustrative system for preference-based call forwarding;

FIG. 2 is a flow chart of an illustrative procedure for forwarding calls based on user-specified preferences;

FIG. 3 is a flow chart of an illustrative procedure for forwarding calls based on time preferences selected by a user;

FIG. 4 is a flow chart of an illustrative process for forwarding calls based on the location of the user; and

FIG. 5 is a flow chart of an illustrative process for forwarding calls based on user-specified preferences, incorporating a landline telephone, according to an illustrative embodiment.

### DETAILED DESCRIPTION

In accordance with an illustrative embodiment there is provided a system and method for forwarding telephone calls to a plurality of “virtual” numbers, associated with a user cellular telephone that has a single “base” number. The base number is the number that the user “owns” as the telephone number representative of the user cellular telephone itself. The virtual numbers are each representative of a distinct entity for the user, according to preferences set by the user that determine when the user desires to receive calls for that particular entity. The entity may be any “location”, real or imaginative, such as a home, office building, virtual office, vehicle, summer home, cellphone, or other entity to which a separate, distinct (“virtual”) number is assigned. The system forwards calls to the called party on a single device, such as a cellular telephone (cellphone), but only when the user desires to receive the call. The user cellphone is described herein as a “Multi-Number Cellphone” (MNC), as it acts as a receiver for multiple phone numbers. The MNC can be any device capable of receiving an incoming call and is not limited to cellular telephones (e.g. personal digital assistants (PDAs), pagers, two-way radios, personal computers (PCs) and other text messaging devices). The calls are forwarded to the MNC according to preferences determined by a user (i.e. the called party having a plurality of virtual numbers) such as location, time-of-day, date, and other preferences.

The Multi-Number Cellphone (MNC) can be a GPS or MPS located handset having special software loaded thereon that enables the functionality described herein. It can work in conjunction with a server and one or more “virtual” phone numbers allocated to each cellphone. A virtual phone number can be one that does not directly ring a unique phone device but rather is routed through a server which controls the forwarding of the call. The virtual phone numbers can be location-dependent in which the server routes calls to the MNC handset depending on its location as determined via a locating system such as GPS or MPS. The MNC would also typically be assigned a regular cellphone number which would be routed to the handset in the normal fashion via the cellphone network. With such a system, users are able to enjoy the use of a single, mobile handset that behaves as if the user has separate home, office, and mobile phones, each with its own respective number.

The functioning of the system can be largely transparent to persons calling MNC users. These callers obtain a “virtual” home or office number from the user as they normally would, and dial these numbers as if they were stand-alone phones residing in those locations.

The MNC user can also behave largely as before, providing his or her contacts with home and office telephone numbers in the traditional manner, however receiving only “home” calls while at home and only business-related calls while at the office. The MNC typically requires certain setup steps to be operative as a multi-number receiver, such as specifying the location or locations associated with each virtual number. The benefits to the user are multiple, and include having only one telephone, one consolidated voicemail message storage, and a lack of undesired calls reaching the user at an inopportune location or time-of-day.

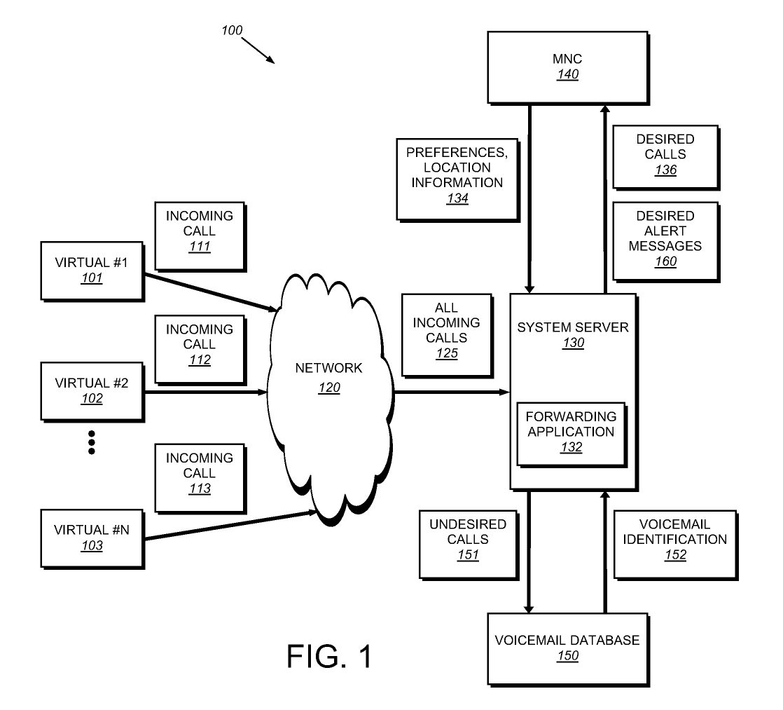

An incoming call is transmitted through the system according to the general architecture shown in FIG. 1. During initial set-up of an illustrative system, the user is assigned separate “virtual” phone numbers, each representative of a distinct entity, serving for example as a virtual home number 101, a virtual office number 102, a virtual cellphone number 103 or other virtual location phone numbers. Users provide these numbers to the outside world as they would normally give out numbers of location-specific, landline phones such as a home phone or office phone. That is, business-related parties would get the office number but not the home number, and personal contacts would get the home number, but not necessarily the office number. A person can get more numbers as well, representing second businesses, vacation houses, etc., or in the alternative, representative of another time-based entity, such as a separate number to have for working hours and another number for all other hours, such as during travel times.

According to an illustrative embodiment of the system, calls dialed to the virtual phone numbers are transmitted to a network 120, for virtual number 101 via data stream 111, for virtual number 102 via data stream 112, and for virtual number 103 via data stream 1 13. These incoming calls are all forwarded through the network 120 via data stream 125 to a system server 130 and then forwarded to the user's cellphone—but only when that user is in the appropriate location, or meets other user-specified preferences.

In an illustrative embodiment, if the GPS-enabled MNC phone indicates to the server that the user is at the office, the virtual phone number forwards any calls coming to the virtual office number to the user's cellphone. The same applies for a virtual home number. If the user is not at the appropriate location, then the call is not forwarded and goes into the voicemail database. In this manner, the distraction of receiving home phone calls at the office on one's cellphone, or business-related calls when not in the office would be eliminated.

The system server 130 is responsible for determining which calls a user desires to receive. Accordingly, the server employs a forwarding application 132 to determine if it is a desired call. The forwarding application determines which virtual number was dialed by the calling party and then determines if the preferences set up by the called party indicate whether the call should be forwarded to the user.

In the initial set-up of the system, a user, via his MNC (Multi Number Cellphone) 140 can enter a set of preferences that are transmitted to the system server 130 via datastream 134. These preferences notify the system server of which calls a user desires to receive. The preferences may be specified based on location of the user, for example. In such a case, the location information of the user is also transmitted to the system server 130 via datastream 134. The preferences may also be set-up by a user on an alternate device, such as a Personal Computer (PC).

The desired calls are forwarded to the MNC 140 via datastream 136 so the user can answer the desired phone call. The undesired phone calls are transmitted to a voicemail database 150 via datastream 151. The greeting message for such voicemails can be tailored to the virtual number being called. For example, the virtual office number can inform the caller that he or she had called XYZ Company and request that a message be left, while the virtual home number can answer the exemplary greeting, “Dude, leave a message”. This allows users to maintain a plurality of voicemail greetings, each distinct and custom to the virtual number that was dialed.

If the calling party leaves a message, there is a voicemail notification that is transmitted to the system server 130 via datastream 152. This then notifies the user that a message has been left by sending an alert to the MNC 140 via datastream 160. Voicemails recorded on the server would be indicated to users via the usual audio and visual means. Voicemails can also be emailed to users or retrieved by calling in. In addition, an alert notifying a user of the existence of voicemails on the server can be communicated to users via, for example, SMS messages sent to the user's cellphone. SMS (“short message service”) is a communications protocol that allows cellphones to interchange messages (typically text messages) with other cellphones and/or other devices. Simple SMS messages are commonly used in the art, beginning in the 1980s, to alert a mobile user of a deposited voicemail. SMS messages can similarly be sent to the MNC to notify the user that a voicemail has been stored in the voicemail database. These text messages can be filtered such that only certain phone numbers (as noted by caller ID) resulted in SMS messages being sent. The user can specify preferences to determine which SMS messages are forwarded to the MNC, and when they are forwarded.

Furthermore, voicemails can be analyzed by a voice-to-text system to produce a text output of the message. This text can accompany the copy of the voicemail sent via email or can be sent via SMS message as well, to provide the user with a text message of the voicemail, or a summary thereof.

On their MNC handset, users would see the normal list of incoming, outgoing, and missed calls, however, they would be able to sort these by their association with virtual numbers if desired. Multiple voicemail boxes can also be implemented to segregate messages associated with different virtual numbers, although these messages can be consolidated, as well.

In those situations where a user may wish to have the opportunity to receive such out-of-location calls (that is, a call to virtual number that was currently being shunted to voicemail), the MNC handset can be programmed to ring in a different manner for such calls. Such calls might be classified by referencing Caller ID (CID) information against a contact database stored on the MNC. Alternatively, if a user was waiting for a call from a particular out-of-location caller, the system can be programmed to allow such call or calls to come through.

In those cases where the MNC owner wished to at least be aware that an out-of-location call had come in, the server can send a text message to the MNC advising the user of such a call had been missed or that a voicemail had been left. Voice analysis software can be used by the server to convert all or part of the voicemail into text that can then be communicated via the text message as well. Alternatively, such text can be made available over the Web, which can be accessed by the MNC.

The virtual numbers can receive text messages, which can be handled by the server and then be forwarded to the MNC handsets. Thus MNC users can receive text messages sent to their virtual home or business phone lines-something that would not be possible if those lines were traditional landlines. Again, to avoid the distraction of receiving unwanted messages when in a specific location, text messages sent to a specific location-dependent number can be stores by the system server until the MNC user is in such location again. At that time the server sends the user the stored text messages. Alternatively, all text messages can be sent in real time, however, metadata associated with the text messages alerts the MNC handset to messages that were sent to virtual numbers that were currently “silent”. In such cases, the text message can be received and stored by the handset and available upon request but the audible or vibration-based notification of such incoming message can be modified to signify it came from an out-of-location caller or there can be no notification at all produced by the handset. Normal notifications can be produced when the user arrived at other locales or the silent numbers were re-activated via some other means. The audible or vibration-based notifications associated with voicemails can be handled in the same manner.

The MNC system can be implemented by having all telephone calls dialed to the virtual numbers forwarded to a single system server, or in the alternative, more than one server can be used, with each server handling a specific location-dependent phone number. These servers can also be operated by a phone company or be independently operated. The cellphone can operate on a cellular network in the usual fashion without requiring any change to its servers or service, which can be employed through the installation of additional software on the MNC itself, so that it can properly function as a receiving device for multiple virtual numbers.

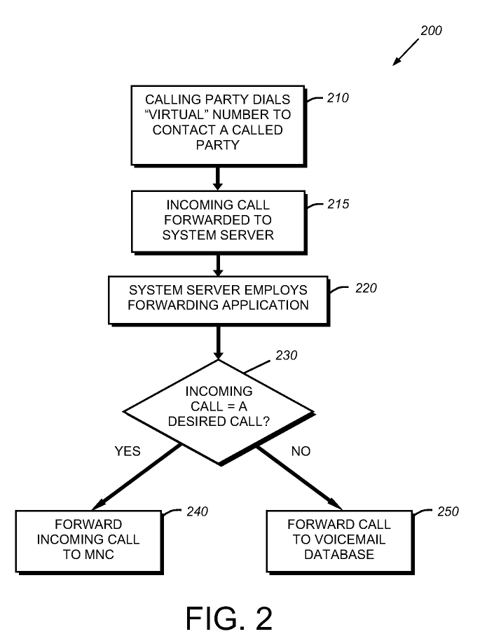

The illustrative system forwards calls from a calling party to a called party (of the called party's voicemail, depending on the user preferences), according to an exemplary call forwarding procedure 200, as shown in FIG. 2. As preciously described, a calling party dials one of a plurality of “virtual” numbers to contact a called party, as shown at step 210. The calling party dials the virtual number in the same manner as through he or she is unaware of the lack of a landline phone corresponding to the virtual number. At procedure step 215, the incoming call is forwarded to a system server, which, according to this embodiment, handles all of the incoming calls for the system. As discussed herein, in alternate embodiments, the system may employ a plurality of preference- or location-specific servers, for handling the different virtual numbers according to the location and/or other preferences specified by the user corresponding to the virtual number.

The single system server of the illustrative procedure 200 employs a forwarding application at step 220, which determines if the incoming call is a desired call at step 230 by verifying the user-specified preferences. For example, a user can desire that when at location #1 (home), the MNC receives incoming calls directed at virtual #1 (“home” phone number). When an incoming telephone call is transmitted to the system server, the forwarding application determines if the user is at location #1 (home), and if they are, then the application forwards the call to the MNC user at step 240. In the alternative, if the user is not at the location #1 (home), then it is not a desired call for the user, and the call is therefore forwarded to a voicemail database at procedure step 250.

This embodiment is desirable, for example, when multiple distinct locations are each frequently visited by a user, allowing them to provide multiple “virtual” numbers for each of the distinct locations, while maintaining a single device. Multiple virtual numbers also provides a user with the opportunity to filter out undesired calls, so as to virtually eliminate undesired interruptions from callers. Particularly, for example, when a person utilizes their cell phone for multiple business calls, it is highly desirable for the user to not receive personal and other household phone calls and inquiries during the course of business.

In an illustrative embodiment, a user can alter the geographically-based rules such that calls can be routed to an MNC handset even when not in the designated location. For example, if a user wished to answer office calls while at home over a particular weekend, the server can easily be reprogrammed to pass office calls through if the MNC user was in certain additional locations or any location. This is akin to call forwarding one's office number to a home number. Such forwarding of calls might be function of time. That is, an MNC user might wish to forward all office to the home between certain hours on Saturdays.

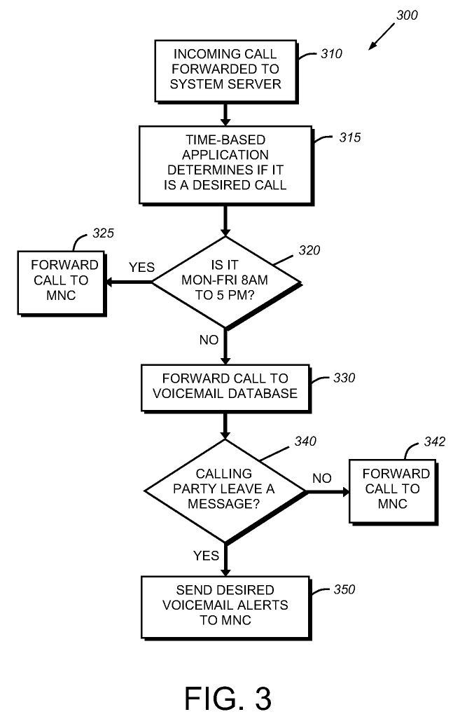

In an alternate time-based embodiment, shown in FIG. 3, a user may set up purely time-based preferences for determining which calls are forwarded to the user. Also, call forwarding based on time parameters can be particularly useful for users having a single location for multiple entities, such as those who work at home. For example, this allows a person working from home to maintain distinct operations for home and business, using, for example, a single phone while maintaining separate phone numbers for personal, home-related matters and another for business matters.

This is highly desirable, for example, for a person who works from home, but still desires to have a distinct home phone number and business phone number, and only desires to receive business-related phone calls from, for example, 8 am to 5 pm, Monday through Friday.

The method by which calls are forwarded to the user, depending on time-based preferences, is shown in the exemplary time-based forwarding procedure 300 of FIG. 3, in which a calling party dials the user's business phone number. As shown, at step 310, the incoming call, directed to a user's business phone number is forwarded to the system server. The system server employs a time-based application at step 315 to determine if it is a desired call. This is performed by decision step 320, which determines if it is Monday through Friday, 8 am to 5 pm, to determine if this is a call which the user desires to receive. If it is during the opportune times, the procedure forwards the call to the user on his or her MNC at step 325. In the alternative, if it is not the appropriate time parameters for which the user has specified forwarding calls to the business number, the call is forwarded to a voicemail database at step 330.

As discussed generally above, if a voicemail is left on the database by the calling party, SMS, or other type messages, can be transmitted to the user to notify them of such message. The procedure 300 determines if the calling party has left a message at step 340. If they have not left a message, at process step 342 the procedure determines no further action is required. However, if the calling party does leave a message, then (if desired by the user), voicemail alerts are sent to the user on the MNC at step 350.

In another variant of bending the geo-based rules for an MNC, a user might allow certain callers to always get through regardless of where the MNC user was, or to get through if the MNC user was or wasn't in certain locations. Thus, a very important customer, identified via caller ID or other means such as answering a question posed by the server might be routed to the MNC no matter the location or if the user was in any of a number of specified locations. Such an arrangement brings that customer one step closer to actually having the mobile number of the MNC user.

Caller-Based Forwarding

In another variant of bending the geo-based rules for an MNC, a user might allow certain callers to always get through regardless of where the MNC user was or what the time was, or to get through if the MNC user was or wasn't in certain locations. Thus, a very important customer, identified via caller ID or other means such as answering a question posed by the server might be routed to the MNC no matter the location or if the user was in any of a number of specified locations. Such an arrangement would bring that customer one step closer to actually having the mobile number of the MNC user.

On the other hand, some callers who may have obtained a user's mobile number might call such number thus incidentally avoiding the location-based or other screening algorithms. The MNC handset software, however, can use CID information and the user's contact database to determine which virtual number the caller was associated with and therefore apply the screening rules in effect at that time and place for such callers.

Additional forwarding rules might revolve around the fact that the MNC user was in motion. That is, the GPS system might report that the user was moving, for instance in a car. Under that circumstance, perhaps all home and office calls would be routed to the user.

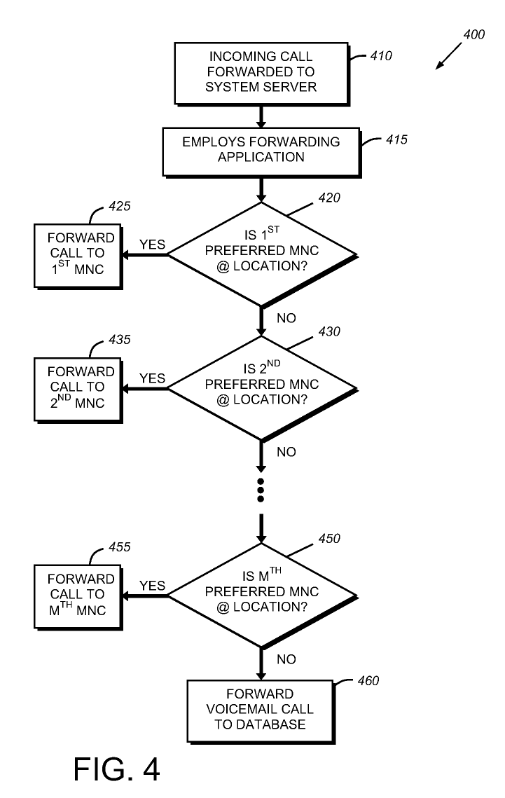

Another rule set might take into account the location of other members of a group, as will be discussed below in conjunction with FIG. 4. For instance, if the server knew that a married couple was together, it might route house calls to one or the other or both spouses.

Call Lists

MNC users can access their lists of Missed, Sent, and Received Calls sorted by virtual number. Thus, when at the office, a user is able to use their handset to see the activity that had recently occurred on the home virtual number. Voicemails and text messages can also be accessed. Such metadata about activity on silent virtual numbers can be communicated to the handset in real time but without notifying the user but available for access if desired.

The MNC can work by having the GPS cellphone report its position continuously to the server using technology similar to that used by teenage-tracking cellphone services and other similar services. It is becoming standard for cellphones to come equipped with GPE enabling technology for locating the cellphone.

Cellular phones can also be located using the Mobile Positioning System (MPS) as described in U.S. Pat. No. 6,799,048 issued to Wahlberg et al. on Sep. 28, 2004. In addition, hosted, server-based systems for handling incoming phone calls directed to telephone numbers assigned to subscribers in a manner specified by preferences submitted by the subscriber via a web interface are now in widespread use, and one such system is described in U.S. Pat. No. 6,445,694 issued to Robert Swartz on Sep. 3, 2002. Server-based systems for routing telephone calls to cellular phones based on their locations are described in U.S. Pat. No. 6,788,766 issued on Sep. 7, 2004 to James D. Logan and in U.S. Pat. No. 5.978,673 issued on Nov. 2, 1999 to Vladimir Alperovich. The disclosures of each of the foregoing four patents is incorporated herein by reference.

However, constant tracking of the cellphone would require constant communication with the server, which can be costly due the use of bandwidth. In the alternative, if the MNC system was implemented by a cellular operator, however, the cost would be minimal as approximate cellphone positions are known by the operator. Data channels are often sold, however, with flat-rate pricing, so location can possibly be streamed to the server in this manner providing real-time, low-cost, continuous location data.

In the alternative, a more cost-effective method is to have the cellphone merely report that it has arrived at or departed from a designated location. Again, this might be best done over the data channel if possible. The server then knows if the user is at home or at the office and filters the virtual phone numbers to the cellphone as is appropriate.

Note, that the location information can be approximate. For example if the user appears to be close to the office, the server can assume the user is in the office for call forwarding purposes. Such approximations can improve functionality given that GPS signals are frequently unable to penetrate typical structures. As such, the location of the user can be assumed to be the location from which the last signal is obtained. Location information might also be based on, or supplemented with ell-known radio frequency triangulation from cellphone towers as an effective alternative to using GPS location data. It is desirable to employ these well-known triangulation principles for location determination given that cellphone signals can penetrate into buildings. In the event that triangulation is employed, the data can be transmitted back to the server via the user's cellphone, or correlated by the cell sites and forwarded through the cellular telephone service provider to the server.

Displaying Metadata Regarding Incoming Callers

As incoming calls to virtual numbers are routed through the server, the original CID information can be preserved and presented to the MNC. The MNC user, however, may wish to receive more information about the caller, such as which virtual number the calling party dialed. Thus, the user may desire to know which class of call the caller represents-personal, business, or other-particularly in those places or at those times when more than one type of caller may be forwarded to the MNC. If the caller is in the MNCs address book this metadata is available and thus can be displayed. If the caller is a new caller (i.e., a caller not listed in the MNC address book), such metadata is not available on the handset. Therefore it is advantageous to have the server communicate information concerning the virtual number called, and thus what class of caller it is (home, business or other) and other information about callers that resides on the server via a separate parallel communications means as described above. Such metadata can then be displayed on the handset.

One exemplary use for metadata transfer is to alert an MNC user that an important customer is calling. This can be accomplished by providing a special virtual number to the important accounts and the handset can display to the user that the call is being forwarded from that special number, such as a “customer hot-line”. Alternatively, such important accounts can be tagged as such in the contacts database, and a copy can be stored directly on the MNC, and such metadata displayed as the call came through. In other cases, such metadata can be used to shunt such calls to voicemail.

The MNC principles can also be employed by a group of persons according to an illustrative embodiment, such as that shown by the method steps of FIG. 4. For example, a household in which one or more members have a MNC device can create a “virtual family phone number”, akin to a traditional landline household telephone number that is shared by everyone in the household. Each member of the family is assigned the same family phone number as one of its virtual numbers. This can be a location-based number (i.e. within the house) or time-based (i.e. Saturdays and vacations, for example). With such a system, a family, business or other group can enjoy the benefits of a common family phone number without the need for a physical landline phone

FIG. 4 is a group use forwarding procedure 400. In the illustrative procedure, if any member of the family is “home” (i.e. at a home location, or during the desired time, as can be reported by their GPS phone to the server) an incoming “family phone call” can be routed to that cellphone through the server. In one embodiment, according to a priority system set-up, if multiple persons are at home, the server forwards the call to the person highest on the list first. The incoming call is first forwarded to the system server at step 410, which employs a forwarding application at step 415. The procedure 420 begins the preference sequence by determining if the first preferred MNC is at the location. If the first preferred MNC is at the location, the call is forwarded to the first MNC at procedure step 425. If the first preferred MNC is not at the location, the forwarding application determines if the second preferred MNC is at the location at procedure step 430. If the second preferred MNC is at the location, the call is forwarded to this second MNC at procedure step 435. If the second preferred MNC is not at the location, others family members at home can be called in sequence (with perhaps more than one MNC ringing at once) if the person who is being rung did not answer in time. As shown in FIG. 4, this continues until the final (Mth) preferred MNC is located to determine if it is at the desired location at step 450. If it is, the call is forwarded to that Mth MNC at step 455.

In an alternate embodiment, more than one member's MNC can be called at the same time, with the call going through to the one that answered first. In this manner, no sequence of preference would be required, and the phone would simply ring through to all MNC users at the location, and the first to answer would receive the phone call.

In another variation, the server can create a conference call with three or more parties if more than one MNC answers the incoming call. This is as if two or more persons in the household pick up different extensions to talk to a calling party. In order to implement this feature, the server can continue to call some or all of the group member's MNCs even after one party had picked up. The extent of such “over-ringing” can be programmed beforehand. Using in-band signaling, however, the MNCs that had not picked up the call can turn off their ringers while the server continued to try to reach them for some period of time after the first MNC answers the household call. This allows the other handsets to merely jump on the call (as if they pick up another landline handset) by answering their phone in the traditional fashion (opening the clamshell, hitting “Send”, etc.)

The server can also examine the CID of the incoming call and match it with a database of contact information provided by each member of the group to determine if the call is most likely for one or more individual members of the group. If such a determination is made then the server calls only those handsets. If nobody answers, the system can try to telephone other group members.

Each group can have one controlling member who can set group-wide parameters for the system, such as the circumstances controlling over-ringing and how long it lasts, which members' handsets ring for what types of calls, etc.

If a member's MNC rings and the user sees (via CID) that the call is not for that member, the user can terminate the ringing and the attempted call connection by “declining” the call by merely pressing a button on their handset. Such an action leaves other member's MNCs ringing and does not send the call into voice mail. Each MNC handset shows which other phones are ringing while any given call is coming in. In the case where a call is directed to multiple phones, and all the other members have declined the call, a declination by the last ringing handset sends the caller into voicemail.

In addition to declining a call, users can also hand off incoming calls without even answering the phone. For instance, if the system forwards to a salesperson's handset and such salesperson realizes that the call should go to the manager, for instance, and such manager's handset is not being rung, the salesperson can activate a command on the handset that communicates to the server that the manager's phone should now also be rung.

Other forms of conference calling can be built around the scenario of multiple persons with MNCs being at home. Suppose, for instance, that one household party wants to join in the call described above after they have declined to answer the call the first time. With a traditional landline, that can be accomplished by simply picking up another extension on the landline. With MNC software installed on the server and on each “household” MNC cellphone, an MNC user can join in on the household call by merely pressing the “Household” button presented on their phone. This action can connect the handset with the server which can then patch the new participant into the conference call. Such secondary callers can be patched into conversations where an outside party has called in and where someone at the house had called out. The ability to add another member of the household or group to the conversation can be restricted to those members currently located in the household or there can be no location restrictions.

In another variation of such group calling, the MNC user who is on the line with the outside party can request that another user join the call. Activating a command on the handset indicating which group member is desired on the phone call, while still on the phone with the outside party, allows for this functionality. This action can result in a signal being sent via a parallel transmission means to the server that results in the server then calling the desired party. If the desired party answers the call they can be conferenced into the on-going call.

The household member making the request to join the call can invoke the option to have the other household MNC automatically answer the incoming request from the server in a speakerphone or push-to-talk mode. The receiving MNC user can also have their handset configured such that a speakerphone answer mode can be used at that time. Such speakerphone mode can be two-way such that sound from the party being conferenced-in can be heard immediately by the other persons on the line allowing the party being called to respond without picking up their phone. Again, the availability of such a feature set can be controlled by the location of the MNC.

Other members of the household, such as children, can have “subsidiary” MNC phones. These phones do not ring when outside parties call the household number, but can easily join a conversation by hitting their Household button. In addition, they can dial out using the family number as their caller ID if they wished.

Groups can also enjoy some of the cellphone handset features associated with individual calls. For instance, the call lists on their phones can show all the incoming or missed calls whether they answer them or not. Outgoing calls made by other parties sharing a location-dependent number can also be shown. The display can show which party within the group made or answered each call, as well other metadata, such as the length of call, which is normally shown on such call lists.

This system of aggregating call information across the sharing group, however, can offer various privacy options. For instance, a user might decide to not have a specific incoming call that he or she answered, or outbound call that he or she made, listed in the call list. In addition, CID information can be automatically used by the system in deciding when to put such call information on the common list. For example, if a customer calls who is already assigned to a particular salesperson, only that salesperson can see the calling information. If someone else answers the call, that person's call list also contains the information, but not the whole group. A call coming from a new account without an assigned salesperson, however, can show up on the group list.

An MNC user can be able to view Sent, Received, and Missed Call lists that comprised group calls that are handled by that particular MNC. In addition, a separate list can be viewed of group calls handled by other group members, provided such call information is not private or otherwise protected. In addition, a combined set of lists, or one list combining Sent, Received, and Missed Calls can be viewed with notation showing which member (the user of the MNC or other group members) is associated with the call.

In addition, voicemail can be a shared function within the group sharing a phone number. With this system, each user of a group number is notified that a voicemail resides on the server. The voicemail system can be set up such that any member of the group can retrieve the voicemail. The system can be configured such that one or more users must to listen to a message before it can be deleted. The server can also convert voice messages to text using voice recognition software. Semantic analysis software can be used to determine which specific member of the group, if any, the calling party is requesting. If it is determined that a specific person or persons is requested, then only those persons would be notified of the voicemail or such notification can be accomplished in a different manner to signify such an association. Alternatively, the voicemail can be made available to only those individuals of the group that are associated with the voicemail. In addition, the voicemail, in either audio form, text form or both, can be emailed to the member or members of the group for which the message is intended.

Privacy options based on CID information as discussed above can be used for this feature as well. That is, messages left from friends of an adult in the household, such friends identified by CID and an associated database residing on the MNC server, are only be available to that adult. In addition, the party calling in can explicitly request that the message be left in one specific member's private mailbox. In either case, this is similar to messages on a home answering machine that are left in a specific “mailbox” on that machine.

Text messages can also be handled by a group number system in a manner similar to that by which voicemail is handled. Unlike voicemail, text messages can reside locally on the handset. If certain text messages are desired to be read by a limited subset of group members only, then information regarding which messages had been read by whom can be circulated among the handsets so that superfluous copies of a text message can be deleted. Such deletions can occur by the server sending such metadata about who has read which text message to any handset from which the text message should be deleted.

The group calling features and functionality described above can also work even when one or more MNC's are not in location-independent mode. In an alternate embodiment, one or more users within a group can allow calls to the group number to be forwarded to their handset regardless of their location. For instance, the mother of a household might wish to receive all household calls no matter where she was located. The father, however, might still only wish to get such calls while at home. Regardless of who is filtering the group calls by location, the overall sharing features can still work.

Group Status Map

Another social calling feature offered by this invention, the Group Status Map, can assist in determining who within a group might be available to join a call. The feature can comprise a map showing the location of each member, similar to the maps created by and provided by Loopt In the commercially available cellphone-based sharing service from Loopt of Mountain View, Calif. Loopt In operates by automatically forwarding SMS-based messages between subscribing users' cellphones in a group so as to allow updating as to a group members' locations on a general map instantiated within the user's cellphone. The map can additionally show, however, whether each member is on a telephone call and, if so, to whom they are talking. Users can interact with the map by clicking on the location of a group member to conference them into a call or to transfer a call to the member.

The map can have the novel feature of a time bar. By sliding such time bar, a user can roll the map back in time and see where each member of the group was at a given point in the past. Furthermore, the map can illustrate if the member was on the phone at that particular time in the part and, if so, with whom. An alternative to an analog control for rolling back time, the user can also be able to click back in time a single telephone call at a time. Such control redraws and stores the map at each moment a new phone call was established by any member of the group. This backward iterating can focus on one or more individuals in the group to determine the call history.

Integrated with Land Line Use

The MNC system can also work in conjunction with a landline. For instance, a house or business can have a regular or VoIP landline with its own virtual phone number. The server would forward all calls to this virtual number to this landline. If the MNC user, or users, were away from the premises, the server can automatically route the call to these cellphones instead of the landline. This would avoid the tedium of having to setup call forwarding when leaving the premises.

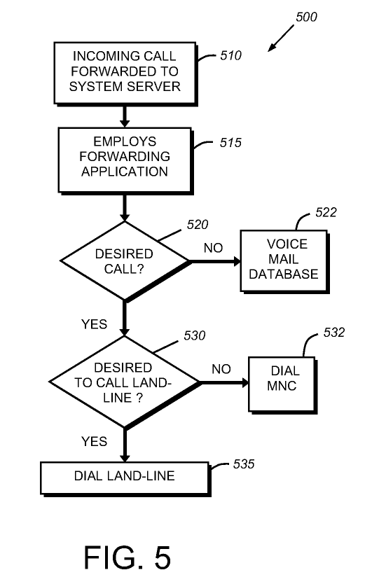

In an alternate embodiment, a landline telephone can be incorporated as another MNC, and called as desired in the manner as shown in FIG. 5. As shown in the landline forwarding process 500 of FIG. 5, an incoming call is forwarded to the system server at step 510, which employs a forwarding application at step 512. The forwarding application determines if this is a desired call at step 520. If this is not a desired call for the landline to receive, the call is forwarded to the MNC at process step 532. If the call is a desired call, it is forwarded to the landline phone at step 535.

This automatic call-forwarding to a landline call if the party being called is not at the premise can also be accomplished by the phone operating company. In this way, it can work without the need for a virtual number and routing the call through the related server.

An alternative implementation of MNC technology with a landline can ring both the landline and the MNC handsets of the users that were at the location. That is, if the MNC users were at home, the server can ring the cellphones as well as the landline and the users can answer whichever handset is most convenient at that time.

The system can also compare the CID of the incoming call to see if it can be deduced which member of the household or business might be most interested in the call based on the contact databases that was previously uploaded to the server. If the incoming call can be associated with one or more MNC users to the exclusion of others in the group, only those cellphones are called in that case. With such associations known, both the group landline and the related party's cellphone can be rung or just the cellphone, thus leaving the landline available for another call. This selective ringing of cellphones available at the location can also provide audible information identifying the party for whom the call was intended before looking at the CID or answering the phone.

An MNC user can easily join in the landline call already underway, provided it is being routed through an MNC-enabled server, by hitting a Join In button on their MNC handset, and join the on-going call as described above in the section on Conference Calling. Such an action would connect the MNC to its hosted server which would then connect the MNC to the call to the premises' landline.

Other Considerations

Virtual Caller ID for Outgoing MNC Calls

The MNC can associate one of the virtual phone numbers given to outside parties with each phone number in the user's contact list. This is accomplished by storing the virtual number for which a call is forwarded when a calling party first called the MNC. For example, the MNC can keep track of all the numbers forwarded to it from each of the home or office virtual numbers. In other cases, the association of a contact's phone number with a virtual number can be input by the MNC in a manual fashion as a number is entered into the MNC's contact database. Such associations can also be constructed when the MNC's contact database is first created by assigning all work numbers one virtual number and personal contacts a second virtual number, assuming that such classification is present in the database being synchronized with the MNC database.

When placing an outbound call to a number with an associated virtual number, the MNC user can dial the number in the normal fashion, most likely by selecting the party being called from a list. The MNC handset, however, noting that the number being called is associated with a virtual number, would first call the server (instead of that number). One method of reaching the server would be the dialing of the virtual phone number associated with the number being dialed as such virtual numbers would all be forwarded to the server. Alternatively, the server can have a separate bank of phone numbers that MNCs can call. The number of the party trying to be contacted would then be passed along to the server when the server answered by transmitting such information using a coded signal employing DTMF or some digital means. The server then forwards the call to the number being dialed as indicated by such data transmission. The server can then “spoof” the CID of the outgoing call such that it represented the virtual phone number that the MNC user wanted to present. Spoofing is a common technique known to those skilled in the art, typically performed by a server, such that the outgoing call is represented by the virtual number that a user desires to present to its calling party.

Alternatively, the server can make outgoing calls using the phone line owned and maintained by the MNC user. The party that the MNC user is calling thus views a CID for the incoming call the virtual number that the MNC user is trying to present as the source of the call.

In the case where the phone company might be operating the MNC system, the call can be dialed in the normal manner and the proper CID would be put on the MNC's outbound call after looking up the virtual number that is associated with the party being called. Note this service could be offered by telephone companies as an “add-on” service, allowing users of cellphones to display a particular number for outgoing calls. Alternatively, this service could be provided by an independent operator that implements the system according to current infrastructure of existing telephone and cellphone networks.

In addition to using virtual number associations as established in the contacts database, the MNC user can also use “virtual-number-premise-association”. This illustrative system employs the virtual number associated with the premise from which the call was being placed for the outgoing CID. Such a choice can be easily over-ridden at the time the call was placed, however.

In cases where there was no association in the contact database and the user was not using automatic virtual-number-premise-association as a means of constructing the desired CID, the user can simply select the desired virtual number to be used (and thus CID that shows up on the receiving end) during the process of dialing the number from a simple menu on the handset. Such a menu can specify if the association is permanent or temporary. Thus, a user of an MNC might have a new customer not yet be associated with the office phone but it can be assigned that association during the process of dialing that number for the first time if such association is specified in the process of dialing. If no selection is made, the call is dialed without using a virtual number and the CID displayed to the party being called is that of the cellphone.

A user can also override the association of an outside number and a virtual number, using a different virtual number or no virtual number (in which case, the caller ID would merely be that of the cellphone and no forwarding through the server would be involved.)

The display on the MNC can be programmed to always make it clear which virtual number was being used for any given call. An audible tone, signal, or message can also be used to reinforce this message to the party placing the call.

The CID techniques described above can also be used to send out text messages in such a manner that they had the appropriate CID, as well.

Conclusion

It is to be understood that the methods and apparatus which have been described above are merely illustrative applications of the principles of the invention. Numerous modifications may be made by those skilled in the art without departing from the true spirit and scope of the invention.

The foregoing has been a detailed description of illustrative embodiments of the invention. Various modifications and additions can be made without departing from the spirit and scope of this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, the illustrative processes herein have been described largely in the context of the location of a particular user, in relationship to pre-defined locations as specified by the user. However it is expressly contemplated that any user-specified preferences may determine the operation of the system. Moreover, the various systems and methods herein can be implemented using electronic hardware, software including computer-readable program instructions executing on a special or general-purpose computer, or a combination of hardware and software. Accordingly, this description is meant to be taken only by way of example, and not to otherwise limit the scope of this invention.

What is claimed is:

1. A system for forwarding telephone calls to virtual numbers associated with a user cellular telephone comprising:
a system server, the user cellular telephone being interconnected by a network to the system server so as to send and receive telephone calls through the network;
a forwarding application associated with the system server including information with respect to virtual phone numbers associated with the user cellular telephone, the forwarding application assigning user preferences to each of the virtual telephone numbers based upon at least one of a location of the user cellular telephone and a time-of-day; and
a voicemail database operatively connected with the system server that stores messages from callers to each of the virtual telephone numbers when predetermined location or time-of-day information, in association with the user preferences requires that calls to the virtual number be stored as messages.

2. The system as set forth in claim 1 wherein the user preferences are provided through an interface including at least one of an internet-based application and a cellular telephone-based application.

3. The system as set forth in claim 1 wherein at least one of the virtual telephone numbers is representative of a home telephone of the user.

4. The system as set forth in claim 3 wherein at least one of the virtual telephone numbers is representative of an office telephone of the user.

5. The system as set forth in claim 1 wherein the system server is constructed and arranged to provide textual messaging to the user cellular telephone that a new message resides in the voicemail database.

6. The system as set forth in claim 1 wherein the locational information is provided by the user cellular telephone via a GPS transmission.

7. The system as set forth in claim 1 wherein the locational information is provided using cellular triangulation.

8. The system as set forth in claim 1 further comprising another user cellular telephone interconnected by the network to the system server, wherein the system server is constructed and arranged to forward a telephone call from the caller to each of the user cellular telephone and the other user cellular telephone in a manner of telephone extensions when each of the user cellular telephone and the other user cellular telephone are both located at a predetermined location in accordance with the user preferences.

9. The system as set forth in claim 1 wherein the server is constructed and arranged to deliver a CID to a call recipient from the user cellular telephone that varies based upon the user preferences with respect to each of the virtual numbers and a cellular telephone base number.

10. A method for forwarding telephone calls to virtual numbers associated with a user cellular telephone comprising:
providing the user cellular telephone, the user cellular telephone being interconnected by a network to a system server so as to send and receive telephone calls through the network;
assigning user preferences to each of the virtual numbers based upon at least one of a location of the user cellular telephone and a time-of-day, the assigning performed by a forwarding application associated with the system server including information with respect to virtual phone numbers associated with the user cellular telephone; and
storing messages from callers to each of the virtual numbers in a voicemail database operatively connected with the system server when predetermined location or time-of-day information requires that calls to the virtual number be stored as messages.

11. The method as set forth in claim 10 wherein the user preferences are provided through an interface including at least one of an internet-based application and a cellular telephone-based application.

12. The method as set forth in claim 10 wherein at least one of the virtual telephone numbers is representative of a home telephone of the user

13. The method as set forth in claim 12 wherein at least one of the virtual telephone numbers is representative of an office telephone of the user

14. The method as set forth in claim 10 wherein the system server is constructed and arranged to provide textual messaging to the user cellular telephone that a new message resides in the voicemail database.

15. A method for forwarding calls to a virtual number associated with a plurality of user cellular telephones comprising:
providing a first user cellular telephone, the first user cellular telephone being interconnected by a network to a system server so as to send and receive telephone calls through the network;
providing a second user cellular telephone, the second user cellular telephone being interconnected by the network to the system server so as to send and receive telephone calls through the network;
assigning user preferences to the virtual number based upon at least one of a location of the plurality of user cellular telephones and a time-of-day, the assigning performed by a forwarding application associated with the system server including information with respect to the virtual phone number associated with the plurality of user cellular telephones; and
storing messages from callers the virtual number in a voicemail database operatively connected with the system server when predetermined location or time-of-day information requires that calls to the virtual number be stored as messages.

16. The method as set forth in claim 15 wherein the virtual number is representative of a home telephone of the users and the user preferences are determined by the location of the plurality of user cellular telephones.

17. The method as set forth in claim 15 wherein the virtual number is representative of an office telephone of the users and the user preferences.

18. The method as set forth in claim 15 wherein both the first user cellular telephone and the second user cellular telephone rings to receive a telephone call through the network.

19. The method as set forth in claim 15 further comprising forwarding the call to the first user cellular telephone.

20. The method as set forth in claim 19 further comprising forwarding the call to the second user cellular telephone when the first user cellular telephone is not available.
